(19) United States
(12) Patent Application Publication
(10) Pub. No.: US 2012/0079489 A1
(43) Pub. Date: Mar. 29, 2012

(54) Method, Computer Readable Medium And System For Dynamic, Designer-Controllable And Role-Sensitive Multi-Level Properties For Taskflow Tasks Using Configuration With Persistence

(75) Inventors: Chiheb Charrad, Neunkirchen A. Brand (DE); Andreas Schülke, Herzogenaurach (DE)

(73) Assignee: Siemens Aktiengesellschaft, Munich (DE)

(21) Appl. No.: 13/162,609

(22) Filed: Jun. 17, 2011

Related U.S. Application Data
(60) Provisional application No. 61/344,752, filed on Sep. 29, 2010.

(51) Int. Cl. G06F 9/46

(52) U.S. Cl. 718/102

(57) ABSTRACT

The method includes determining whether or not a processing level of the task flow is an intermediate processing level. Generating a new property upon determining that the processing level is an intermediate processing level. Associating a relatively lower level property with the new property and publishing the new property to a relatively higher processing level in the task flow.

### PRIORITY

This application claims the benefit of priority under 35 U.S.C. §119 of U.S. Provisional Application No. 61/344,752, filed Sep. 29, 2010, the entire contents of which are hereby incorporated herein by reference.

### BACKGROUND OF THE INVENTION

1. Field

Embodiments relate to designer controlled property assignment in multi-level taskflows.

2. Related Art

An environment where individual software application elements are processed by a user in a defined sequence. The individual software-application building blocks (e.g., tasks) and sequence of tasks are configured and called taskflows. The taskflows define both the position of the tasks and the data links between the tasks. The data links ensure that the output data of one task function is used as input data for a following task. Tasks can typically be executed sequentially, in parallel, or in an arbitrary sequence.

### SUMMARY OF THE INVENTION

One embodiment includes a method to publish a task flow property. The method includes determining whether or not a processing level of the task flow is an intermediate processing level. Generating a new property upon determining that the processing level is an intermediate processing level. Associating a relatively lower level property with the new property and publishing the new property to a relatively higher processing level in the task flow.

One embodiment includes a computer readable medium. The computer readable medium includes a data structure. The data structure includes a task flow, the task flow including a plurality of tasks ordered hierarchically. The data structure includes code segments that when executed by a processor cause the processor to determine whether or not a processing level of the plurality of tasks is an intermediate processing level, generate a new property upon determining that the processing level is an intermediate processing level, associate a relatively lower level property with the new property and publish the new property to a relatively higher processing level in the task flow.

One embodiment includes a medical work flow management system. The medical work flow management system includes a processor and a memory on which a data structure is stored. The data structure includes a task flow, the task flow including a plurality of tasks ordered hierarchically. The data structure includes code segments that when executed by the processor cause the processor to determine whether or not a processing level of the plurality of tasks is an intermediate processing level, generate a new property upon determining that the processing level is an intermediate processing level, associate a relatively lower level property with the new property and publish the new property to a relatively higher processing level in the task flow.

### BRIEF DESCRIPTION OF THE DRAWINGS

The present invention will become more fully understood from the detailed description given herein below and the accompanying drawings, wherein like elements are represented by like reference numerals, which are given by way of illustration only and thus are not limiting of the present invention and wherein:

FIG. 1 illustrates individual building blocks or tasks arranged as a taskflow according to example embodiments.

FIG. 2 illustrates individual building blocks or tasks arranged as clinical tasks and a taskflow according to example embodiments.

FIG. 3 illustrates individual building blocks or tasks arranged as clinical tasks and a taskflow according to example embodiments.

FIG. 4 is a matrix that illustrates a multi-level, multi-user processing of a taskflow according to example embodiments.

FIG. 5 illustrates a property assessor according to example embodiments.

FIG. 6 illustrates a taskflow arranged in a hierarchy of processing levels according to example embodiments.

FIG. 7 illustrates a system for computed tomography according to example embodiments.

FIG. 8 illustrates a method to publish a task flow property according to example embodiments.

FIG. 9 is a schematic diagram roughly illustrating a memory card 900 according to at least one example embodiment.

FIG. 10 is a block diagram roughly illustrating an electronic system 1000 according to at least one example embodiment.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF THE EMBODIMENTS

While example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of the claims. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks will be stored in a machine or computer readable medium such as a storage medium. A processor(s) will perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context, of the relevant art and will not be interpreted in an idealized or overly formal sense unless expressly so defined herein.

Portions of the example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments will be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

In an environment where individual application elements (e.g., software applications) are processed (e.g., by a computer processor or user of the environment) in a defined sequence. The individual application elements (e.g., building blocks) hereafter may be referred to as task(s). A sequence of tasks hereafter may be referred to as a taskflow. The taskflow may define a relative position of the tasks as well as one or more data links between the tasks. The data links typically output data of one task and function as input data for a following or subsequent task. Tasks may be executed sequentially, in parallel, or in an arbitrary sequence.

For example, a task may include configuration files plus assemblies for a frontend (FE) and a backend (BE) part of an application. The task may further include resource assemblies for native language support and other values which tailor the behavior of the application. A task is a reusable item and can be used in different taskflows or also several times in one taskflow. For example, a task may be a viewing task which shows medical images in four segments on a screen or a backend task, having no user interface, which pre-processes medical images and provides data for a display.

A sequence of tasks may be referred to as a taskflow. The taskflow may define a relative position of the tasks as well as one or more data links between the tasks. The data links typically output data of one task and function as input data for a following or subsequent task. Tasks may be executed sequentially, in parallel, or in an arbitrary sequence.

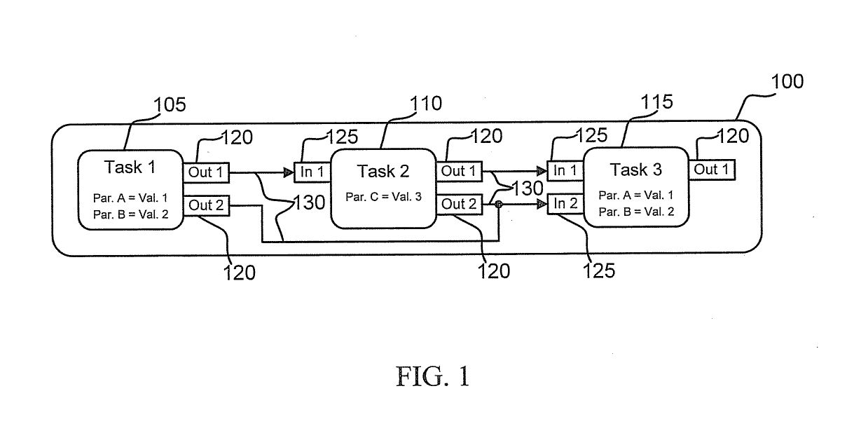

FIG. 1 illustrates an example embodiment of individual building blocks or tasks arranged as a taskflow according to example embodiments. As shown in FIG. 1 a task flow 100 includes three tasks 105, 110, 115. The tasks may be at the lowest processing level of a hierarchical (e.g., multi-level) processing flow or tree.

Each task 105, 110, 115 may include an output 120 and an input 125. For example, task 1 105 includes two outputs out 1 and out 2. Task 2 110 includes one input and two outputs in 1, out 1 and out 2 respectively. Task 3 115 includes two inputs and one output in 1, in 2 and out 1 respectively.

Task inputs 125 (e.g., in 1) and outputs 120 (e.g., out 1) may be referred to as ports. Ports may perform the function of relaying data between a task 105, 110, 115 and a link 130. The link 130 may be a communication channel between two tasks 105, 110, 115. Each of these functions (tasks, ports and links) together may operate as the taskflow 100. The taskflow 100 may have a configuration that references the individual task configurations and models a data flow via the links 130.

The tasks 105, 110, 115 may be reusable building blocks that may be used in different taskflow 100 configurations. Different combinations of tasks 105, 110, 115 may produce different behaviors in the taskflow 106. However, the tasks 105, 110, 115 may also make configurable properties available. The configurable properties are illustrated as properties (e.g., Par.A) and values (e.g., Val. 1). Depending on the value of a property, the presentation, behavior, algorithms, and the like, of the task 105, 110, 115 may change. In this way, reuse of the task 105, 110, 115 may be possible. As such, the task 105, 110, 115 may be a building block with specifically configured behavior associated with each taskflow 100 and/or task 105, 110, 115 configuration.

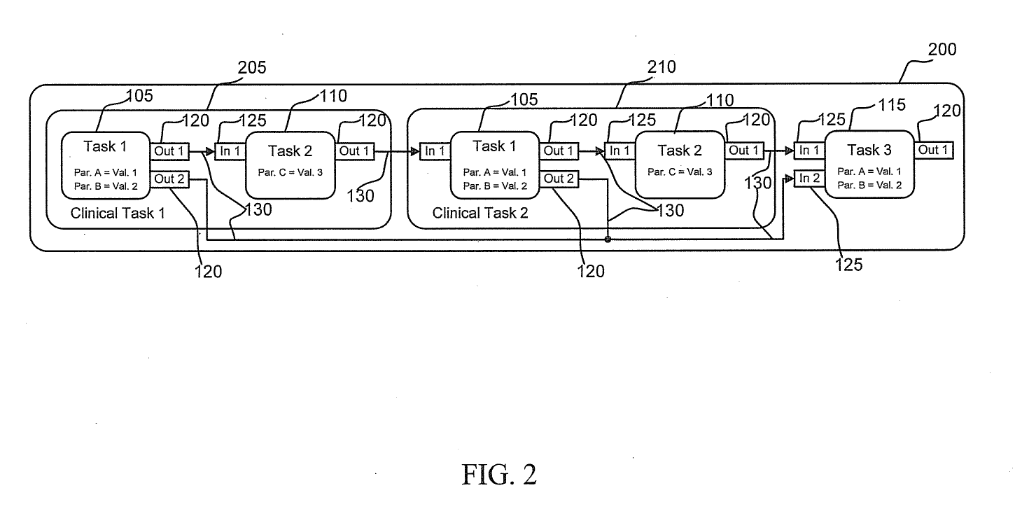

FIG. 2 illustrates an example embodiment of individual building blocks or tasks arranged as clinical tasks and a taskflow according to example embodiments. As shown in FIG. 2 a taskflow 200 includes two clinical tasks 205, 210 and a task 115. Each clinical task 205, 210 includes two tasks 105, 110. The clinical tasks 205, 210 may be at a higher processing level than the tasks 105, 110, 115.

Each task 105, 110 may include outputs 120 and inputs 125. The taskflow 200 includes tasks 105, 110, 115 interconnected by links 130.

For example, in a medical environment, tasks 105, 110, 115 are often joined into a group that performs a specific clinical function (e.g., determine a patient's heart rate). The grouping of tasks may be referred to as a clinical task 205, 210. A taskflow may be configured from a combination of tasks 105, 110, 115 and clinical tasks 205, 210.

Clinical task 1 205 and clinical task 2 210 each may have their own configuration interacting with the configurations of task 1 105 and task 2 110 respectively. In this configuration, according to at least one example embodiment, each of task 1 105 and task 2 110, respectively, may have the same property values and the same behavior.

In at least one example embodiment, reuse of task 1 105 and task 2 110 may be desired. Therefore, the properties within clinical task 2 210 may have different values than clinical task 1 205 and as a result produce partially different behavior with regard to clinical task 1 205. As is known, the configuration of task 1 105 and task 2 110 may be unalterable. Therefore, according to at least one example embodiment, the input properties and/or values of each task 105, 110 of the clinical task 205, 210 may be altered.

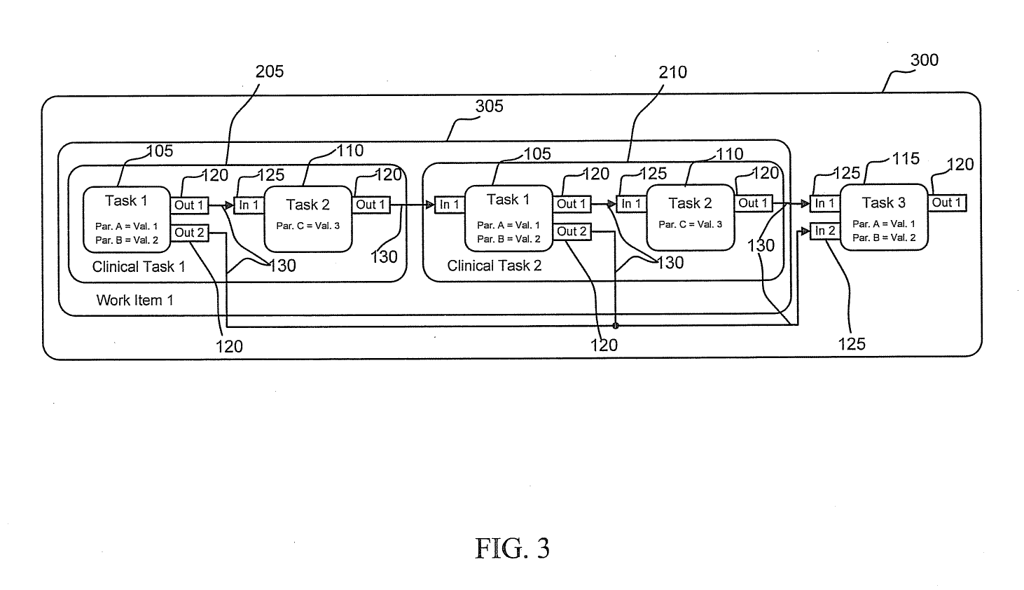

FIG. 3 illustrates an example embodiment of individual building blocks or tasks arranged as clinical tasks and a taskflow according to example embodiments. For example, a work item (e.g., work item 305) may include one or more clinical tasks (e.g., clinical task 205 and clinical task 210 as described above with regard to FIG. 2). As shown in FIG. 3 a taskflow 300 includes a work item 305 and a task 115. The work item 305 includes two clinical tasks 205, 210. The work item 305 may be at a higher processing level than clinical tasks 205, 210. With the exception of the grouping of the clinical tasks 205, 210 into the work item 305, FIG. 3 is substantially the same as FIG. 2.

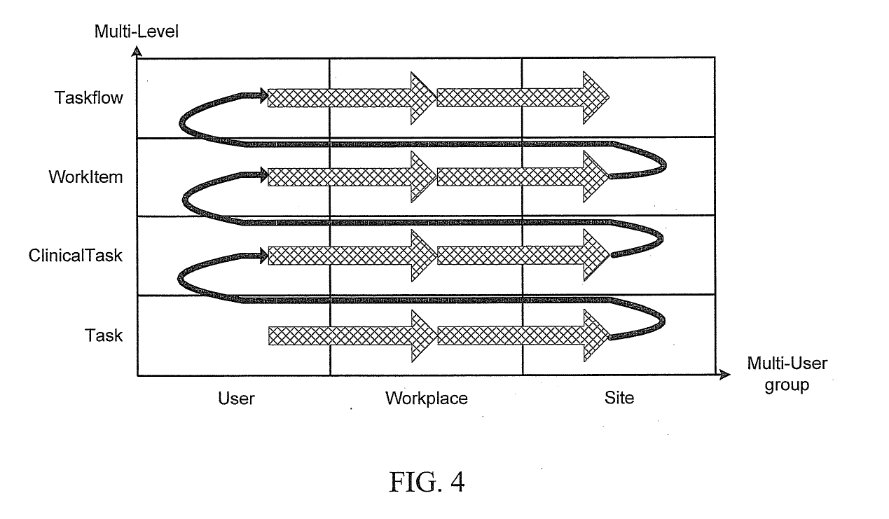

FIG. 4 is a matrix that illustrates an example embodiment of a multi-level, multi-user processing of a taskflow according to example embodiments. As shown in FIG. 4, the matrix may include more than one level. Example embodiments according to FIG. 4 include four levels (e.g., Task, ClinicalTask, WorkItem and Taskflow). Although four levels are shown, example embodiments are not limited thereto.

As shown in FIG. 4, the matrix may include more than one user group. Example embodiments according to FIG. 4 include three user groups (e.g., User, Workplace and Site). Although three user groups are shown, example embodiments are not limited thereto. Example embodiments according to FIG. 4 show arrows across user groups and across levels. For example, a user may be an individual computer, a Workplace may be a division of a hospital (e.g., an imaging division or a recordkeeping division), and a Site may be the entire hospital.

The arrows may illustrate the flow of information (e.g., a value, a variable, an image, a record and the like) and/or a search for information, for example, the data flow via the links 130 described above. If, in the block represented by Task-User, information is required and the information is found (e.g., the value is found on the users computer), the search for the information ends. Otherwise, the search progresses to the Task-Workplace block (e.g., a search is made of each computer in a division). If, in the block represented by Task-Workplace, the information is found, the search for the information ends. The search for the information continues through each level and user group until the information is found. The search may commence in any block. For example, the search may commence in the ClinicalTask-Workplace block.

The matrix may be embodied as a XML data structure. XML data structures are known to those skilled in the art. For example, the following XML data structure may illustrate a single cell of the matrix of FIG. 4.

<PROPERTIES>

<PROPERTY NAME=“MeasurementMode” PUBLISH=“true”
ALIAS=“Task_MeasurementMode”>

<VALUE>Value from Task</VALUE>

</PROPERTY>

</PROPERTIES>
ClinicalTask
<PROPERTIES>

<PROPERTY NAME=“Task_MeasurementMode” PUBLISH=“true”
ALIAS=“ClinicalTask_MeasurementMode”>

<VALUE>Value from ClinicalTask</VALUE>

</PROPERTY>

</PROPERTIES>
Taskflow
<PROPERTIES>

<PROPERTY NAME=“ClinicalTask_MeasurementMode”>

<VALUE CONFIG=“@PathToExternalStorage”> Value from
Taskflow</VALUE>

</PROPERTY>

</PROPERTIES>

As indicated above, the above XML data structure contains a reference to a cell of the matrix illustrated in FIG. 4. The XML data structure references an external storage option. The external storage option may be a databank, a file system, or other storage media with a corresponding structure. The XML data structure may be stored in a memory associated with an imaging apparatus or a memory of computer (e.g., a server) associated with a clinical study. However, example embodiments are not limited thereto.

The correct values for the task-flow properties therefore depend on the hierarchy level (e.g., Taskflow, WorkItem, ClinicalTask or Task) (Multi-Level) and the combination of user, workplace or the range of application of the software installation (e.g., with a server installation). Example embodiments provide a structure for passing the correct values for the task-flow properties for each hierarchy/processing level.

Example embodiments provide that each level (Task, ClinicalTask, WorkItem, Taskflow), in a configuration, may describe a property with a preset value (default) and a name under which the property may be set or configured at the next higher level. The latter does not apply to Taskflow, because it has no level above it. The higher level may, on the other hand, accept the value, change the default value, and optionally pass it on under a different name to the next-higher level. In this way, the same task may be used several times in the taskflow and configured differently, which results in different behavior by the task. Therefore, this may be a hierarchic model that is based on an overwrite method for the parameter values.

Each level may decide whether or not to propagate the properties of the lower level to the next-higher level. Because propagating a parameter upward under a new name may be possible, differentiating between properties in the higher levels (even though the tasks used employ the same names) may also be possible.

Once the hierarchy of properties and their propagation are transparently available, a user dialogue (e.g., a user interface) may easily display the properties that are available at that level, their defaults, and/or selection, and make them variable. Storage (also known as persistence) may take place either at the respective level of configuration (Multi-Level) or be recorded in an external locality. The latter option offers the possibility of sorting the actual values again for a specific user, a workplace, or a site. When determining the property values during taskflow execution, the current user name, the workplace name, and the site are used, may be used in order to read the final value.

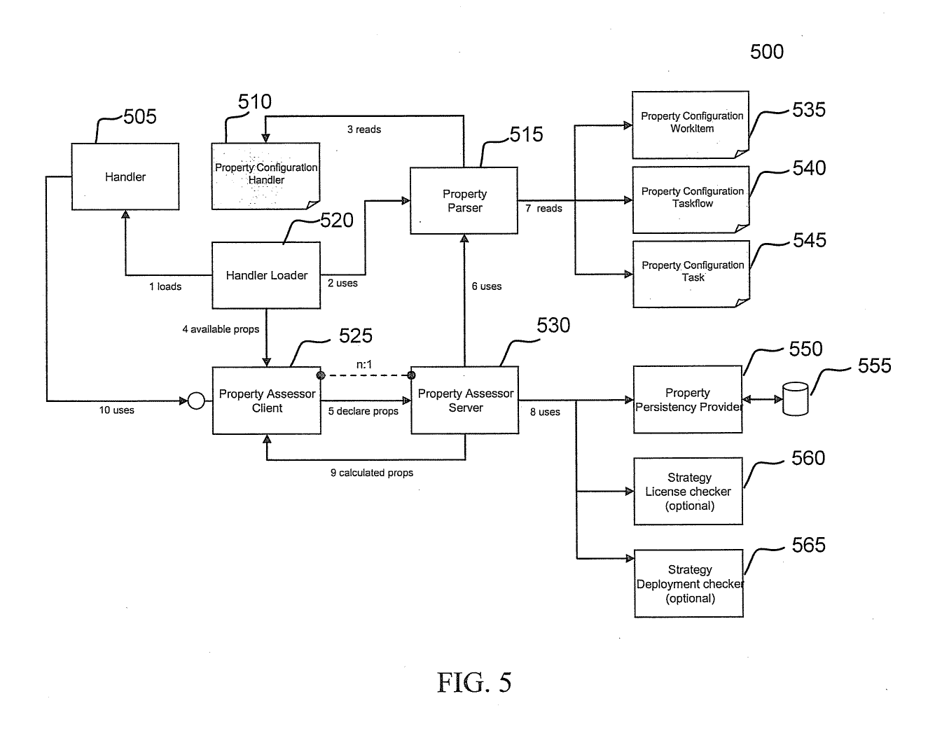

FIG. 5 illustrates an example embodiment of a property assessor according to example embodiments. As shown in FIG. 5, the property assessor 500 may include a handler 505, a property configuration handler 510, a property parser 515, a handler loader 520, a property assessor client 525, a property assessor server 530, a property configuration workitem 535, a property configuration taskflow 540, a property configuration task 545, a property persistency provider 550, a memory 555, a strategy license checker 560 and a strategy deployment checker 565.

The property assessor 500 may be configured to enable one or more task handlers to access properties depending on a current runtime context. The handler 505 is the binary configured with a task's service to process business or presentation logic, which could depend on context sensitive properties. The property configuration 510 may be configured with a handler to instruct the infrastructure that the corresponding handler needs the configured properties for its processing.

The property parser 515 may be configured to provide a common mechanism for parsing property configurations associated with different levels. For example, the property parser 515 may be configured with the handler's property configuration 510 as well as the property configuration task 545, property configuration taskflow 540 and/or property configuration workitem 535.

The handler loader 520 may be configured to load the required handler 505, to fetch the configured properties using the property parser 515, to publish the required properties and trigger the property assessor server 530 to calculate the values depending on the client and server side dependent context, so that the actual values may be accessed by the handler 505.

The property assessor client 525 may be used by the handler 505 to access the actual property values. The property assessor server 530 may be configured to determine the properties that may or may not depend on persisted (stored) data, license availability and deployment strategy. The property assessor server 530 may propagate those properties that are dependant.

The property configuration workitem 535 may be configured to introduce properties in workitem level. The property configuration taskflow 540 may be configured to introduce properties on taskflow level. The property configuration task 545 may be configured to introduce properties on task level. For example, as described above, the property parser 515 may introduce properties at a respective level based on whether or not a level includes properties (as determined by the property assessor server 530) to be stored (persisted) to a each level.

The property persistency provider 550 may be configured to offer a possibility to persist (store) property values for subsequent usage. The memory 555 may be configured as a storage location for the property persistency provider 550. The strategy license checker 560 may be configured to offer a configurable mechanism to consider license availability in property calculation. The strategy deployment checker 565 may be configured to consider deployment aspects in property calculation.

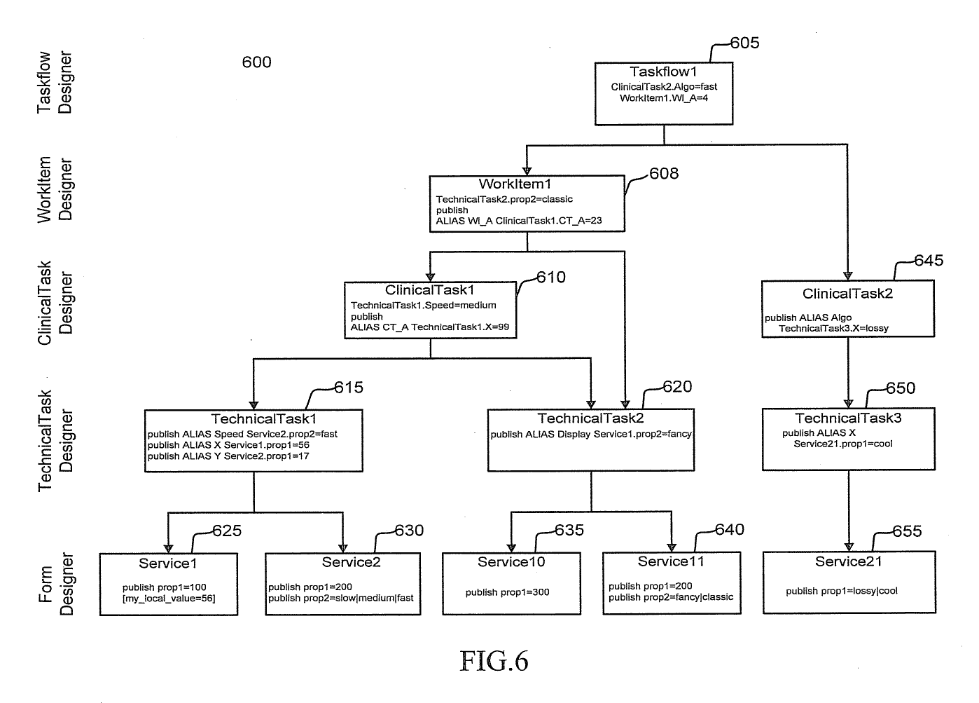

FIG. 6 illustrates an example embodiment of a taskflow arranged in a hierarchy of processing levels according to example embodiments. As shown in FIG. 6, a taskflow 600 may include more than one processing level in, for example, a hierarchical tree structure or flow. As shown in FIG. 6, the highest level includes Taskflow1 605. Taskflow1 605 may include ClinicalTask1 610 and ClinicalTask2 645 one level below Taskflow1 605.

ClinicalTask1 610 may include TechnicalTask1 615 and TechnicalTask2 620 one level below ClinicalTask1 610. TechnicalTask1 615 may include Service1 625 and Service2 630 one level below TechnicalTask1 615. TechnicalTask2 620 may include Service10 635 and Service11 640 one level below TechnicalTask1 615.

Further, ClinicalTask2 645 may include TechnicalTask3 650 one level below ClinicalTask2 645 and Service21 655 one level below TechnicalTask3 650.

FIG. 6 further illustrates each of the process levels may have an associated designer or design tool. For example, ClinicalTask1 610 and ClinicalTask2 645 have an associated ClinicalTask Designer. Service1 625, Service2 630, Service10 635, Service11 640, Service21 655, TechnicalTask1 615, TechnicalTask2 620, TechnicalTask3 650, WorkItem1 608 and Taskflow1 605 may have associated designers Form Designer, TechnicalTask Designer, WorkItem Designer and Taskflow Designer respectively.

As one skilled in the art will appreciate, the designers who produce the configurations for a task (e.g., Service1 625 or Service2 630) typically do not know when and how the task will be used in the future or by higher level designers. In addition, the designers that design the configuration of ClinicalTasks (e.g., ClinicalTask1 610), TechnicalTasks (e.g., TechnicalTask1 615), or Taskflow (e.g., Taskflow1 605), the respective underlying configurations are unalterable (e.g., the properties described above are fixed).

As is shown in FIG. 6, each functional block includes one or more properties or parameters having an associated value. For example, Service2 630 includes property “prop1” having an associated value of “200” and property “prop2” having selectable values “slow|medium|fast”. However, Service11 includes the same named properties “prop 1” and “prop2” with property “prop2” having different selectable values “fancy|classic”.

As one skilled in the art will appreciate, two tasks may be designed by different designers at different times and the use of the same named properties may frequently occur. Those skilled in the art will appreciate that example task flow tools (e.g., Microsoft Workflow Foundation (MSWF)) do not hierarchically group tasks together as described above. Therefore, common property names are not problematic. For example, MSWF executes tasks in taskflows. Comparable MSWF objects are activity (e.g., Task) and Workflow (e.g., Taskflow). The processing levels of ClinicalTask and WorkItem are not directly comparable, even if it is possible to achieve a grouping of other activities with SequentialActivity (MSWF allows for sequential stepping of activities (e.g., tasks)). Therefore, there is no need to develop a method for determining the values of the properties Multi-Level and Multi-User-sensitive in the known taskflow tools.

Returning to FIG. 6, a TechnicalTask may include one or more properties. Each of the one or more properties may refer to a property of a lower level task or service. The TechnicalTask may include one or more properties unique to the TechnicalTask. For example, TechnicalTask1 615 includes three properties. Each of the three properties references lower level tasks (e.g., Service1 625 and Service2 630. For example, TechnicalTask1 615 includes references to Service1 “prop1”, Service2 “prop1” and Service2 “prop2”. The references are shown as Service1.prop 1, Service2.prop1 and Service2.prop2 respectively.

However, as one skilled in the art will appreciate, the property prop 1 is repeated. Therefore, if TechnicalTask1 615 were to publish the repeated properties to ClinicalTask1, errors, unpredictable results and/or unpredictable performance may occur. Therefore, according to example embodiments, an intermediate layer (e.g., TechnicalTask) may associate a new property or parameter name to the lower level property and publish the new property name to higher level layers.

For example, TechnicalTask1 615 assigns an alias to each of the properties associated with Service 1 625 and Service 2 630. For example, TechnicalTask1 615 assigns the alias “X” to Service1 “prop1”, the alias “Y” to Service2 “prop1” and the alias “Speed” to Service2 “prop2”. TechnicalTask1 615 may also assign a default value to each of the properties. The new properties and default values are shown as publish ALIAS X Service1.prop1=56, publish ALIAS Y Service2.prop1=17 and publish ALIAS Speed Service2.prop2=fast respectively.

As will be appreciated, ClinicalTask1 610 is an intermediate layer between TechnicalTask1 615 and Taskflow1 605. Therefore, for example, ClinicalTask1 610 may generate, assign and publish a new property name for a property associated with TechnicalTask1 615 as well. For example, ClinicalTask1 610 assigns a new property “CT_A” to TechnicalTask1 615 property “X”. The new property and default values are shown as publish ALIAS CT_A TechnicalTask1.X=99.

In this way example embodiments propagate an assignment of a value at a higher level element to a lower level element. For example, Taskflow1 605 assigns the value “4” to “WorkItem1.WI_A”. This value assignment by Taskflow1 605 has the effect of assigning the value “4” to property “prop1” of Service1 625 via WorkItem1 608, ClinicalTask1 610 and TechnicalTask1 615.

At least one embodiment may include a medical work flow management system. The medical work flow management system includes a processor and a memory on which a data structure is stored. The data structure includes a task flow, the task flow including a plurality of tasks ordered hierarchically. The data structure includes code segments that when executed by the processor cause the processor to determine whether or not a processing level of the plurality of tasks is an intermediate processing level, generate a new property upon determining that the processing level is an intermediate processing level, associate a relatively lower level property with the new property and publish the new property to a relatively higher processing level in the task flow.

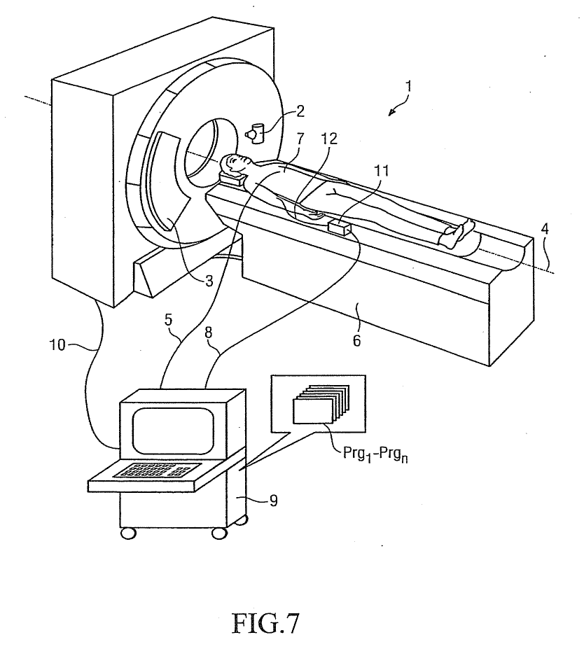

FIG. 7 illustrates an example embodiment of a system for computed tomography according to at least one example embodiment. The system for computed tomography 1 may be a medical work flow management system. As shown in FIG. 7, the system for computed tomography 1 may include an X-ray tube 2, a detector 3, a system axis 4, an ECG lead 5, a displaceable patient couch 6, a patient 7, a control line for the injector 8, a control and arithmetic logic unit 9, a control and data line to the CT 10, an injector 11 an a contrast medium line 12.

As is illustrated by FIG. 7, computed tomography system 1 may include the control and arithmetic logic unit 9 including data memories with programs Prg₁-Prgₙ. As one skilled in the art will appreciate, individual method steps and control tasks may be distributed among different computers within the scope of the example embodiments. The control and arithmetic logic unit 9 shown here is connected via a control and data line 10 to the actual CT, which has an X-ray tube 2 and, oppositely thereto, a detector that is fastened on a gantry and can move on a circular track in order to scan the patient.

During a scanning operation, a patient 7 who is located on a couch 6 that can be displaced in the direction of the system axis 4, is displaced in the direction of the system axis 4 such that, in the final analysis, spiral scanning takes place relative to the patient's coordinate system. The computed tomography system 1 additionally has an ECG that is integrated in the arithmetic logic unit 9 and scans the heart rate of the patient 7 via the ECG line 5. Furthermore, the control and arithmetic logic unit 9 uses the control line 8 to operate an injector 11 with the aid of an integrated contrast medium pump, and via the hose line 12 depicted this injector 11 injects the required contrast medium into the patient's 7 blood circulation at a prescribed flow rate.

According to at least one example embodiment, the programs Prg₁ to Prgₙ stored in the arithmetic logic and control unit firstly push the patient 7 so far into the beam path of the CT that a so-called prescan of a cardiac artery can be carried out. There is no feeding of the patient 7 in the case of this prescan, rather, a tomogram of the heart is produced only in a plane of low dose rate in order to establish the contrast medium filling of an artery essential to the examination.

If the patient 7 is located in the correct prescan position, the injector 11 injects contrast medium at a prescribed flow rate, and either the operator uses the reconstructed tomogram output on a illustration screen to establish when there is a sufficient contrast medium filling in the observed cardiac artery, or an appropriate program can establish via automatic image processing whether sufficient contrast is present in the reconstructed image for a good illustration of the arteries.

As one skilled in the art will appreciate, each of the components of the computed tomography system 1 may be designed by separate entities (e.g., different work centers within a corporation or separate corporations). Therefore, control and operation of each component may have separately designed tasks, workflows, clinical tasks and/or taskflows.

For example, X-ray tube 2 and detector 3 may have an associated operational task (e.g., Service1 625 and Service2 630 described above). For example, X-ray tube 2 may be associated with Service1 625 where “prop1” is an X-ray tube property (e.g., power). For example, detector 3 may be associated with Service2 630 where “prop1” and “prop2” are detector properties (e.g., noise filter and sample rate). A manufacturer may assemble a system including the X-ray tube 2 and detector 3. The manufacturer may design a TechnicalTask (e.g., TechnicalTask1 615 described above) to operate the system including the X-ray tube 2 and detector 3.

For example, the manufacturer may design TechnicalTask1 615 such that each of the properties associated with Service 1 and Service2 may be published to a higher level (e.g., another manufacturer who combines the displaceable patient couch 6 with the system including the X-ray tube 2 and detector 3). The manufacturer design TechnicalTask1 615 as described above with regard to FIG. 6. For example, Service1.prop1 may have an alias of “power”, Service2.prop2 may have an alias of “Filter” and Service2.prop2 may have an alias of “SampleRate”

Another manufacture may design a ClinicalTask associated with moving the displaceable patient couch 6 through the system including the X-ray tube 2 and detector 3. For example, another manufacturer may publish aliases, as described above, to a Taskflow designer (e.g., a third manufacturer). The Taskflow designer may put an entire computed tomography system 1 together further including the arithmetic logic unit 9 and the injector 11. For example, another manufacturer may publish new aliases associated with Service1.prop1 as described in more detail above.

Although the above example was described with regard to a computed tomography system, example embodiments are not limited thereto. For example, system may be another imaging system (e.g., MRI). Further, example embodiments are not limited to imaging systems. For example, example embodiments may be related to a clinical study system or other health care management system. Further, as one skilled in the art will appreciate, example embodiments may be related to any system using tasks and/or workflows and/or taskflows.

The system using tasks may be embodied as a computer readable medium. For example, at least one embodiment may include a computer readable medium (e.g., memory 1020 described below). The computer readable medium may include a data structure. The data structure may include a task flow, the task flow including a plurality of tasks ordered hierarchically. The data structure includes code segments that when executed by a processor (e.g., processor 1010 described below) cause the processor to determine whether or not a processing level of the plurality of tasks is an intermediate processing level, generate a new property upon determining that the processing level is an intermediate processing level, associate a relatively lower level property with the new property and publish the new property to a relatively higher processing level in the task flow.

Further, at least one embodiment may include a method to publish a task flow property. The method includes determining whether or not a processing level of the task flow is an intermediate processing level. Generating a new property upon determining that the processing level is an intermediate processing level. Associating a relatively lower level property with the new property and publishing the new property to a relatively higher processing level in the task flow.

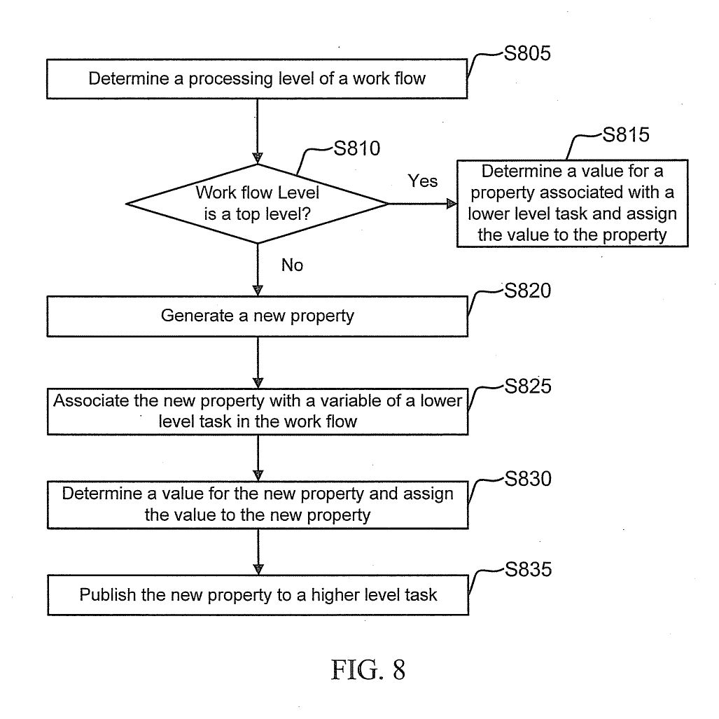

FIG. 8 illustrates an example embodiment of a method to publish a task flow property according to example embodiments. Each of the steps of FIG. 8 may be performed by a subsystem (e.g., detector 3) of a larger system (e.g., computed tomography system 1). Alternatively, each of the steps of FIG. 8 may be performed wholly by the larger system. Each of the steps of FIG. 8 may be performed by a processor associated with the subsystem and/or the larger system.

Referring to FIG. 8, in step S805 the processor determines a processing level of a work flow. For example, as described above, the processor may determine if the level of the work flow is one of a task (e.g., Service1 625), a workitem (e.g., TechnicalTask1 615), a clinicaltask (e.g., ClinicalTask1 610), or a taskflow (e.g., Taskflow1 605). The processor may determine processing level of a work flow based on a system setting, based on a user input and/or (but not limited to) a search for tasks within a hierarchical tree.

In step S810 the processor determines if the work flow level is a top level. For example, if in step S805 the processing level is determined to be a taskflow level, the work flow level is a top level. If the work flow level is a top level, processing moves to step S815. Otherwise processing continues to step S820.

In step S815 the processor determines a value for a property associated with a lower level task and assigns the value to the property. For example, as described above, the processor may assign a value for power of the X-ray tube 2. The setting of this variable may propagate to a service (e.g., Service2 630) to control the power of the X-ray tube 2.

In step S820 the processor generates a new property. For example, as described above, ClinicalTask1 610 may generate a new property name (e.g., CT_A) for a property associated with TechnicalTask1 615. In step S825 the processor associates the new property with a variable of a lower level task in the work flow. For example, as described above, ClinicalTask 1 610 may assign the new property “CT_A” to TechnicalTask1 615 property “X”. The new property and default values are shown as publish ALIAS CT_A TechnicalTask 1.X=99.

In step S825 the processor determines a value for the new property and assigns the value to the new property. For example, as described above, ClinicalTask1 610 may set a default value for a property (e.g., CT_A) associated with TechnicalTask1 615. The default value may be illustrated as “99” in the assignment TechnicalTask1.X=99. In step S825 the processor publishes the new property to a higher level task/task object. For example, as described above, a command statement “publish ALIAS CT_A TechnicalTask1.X=99” publishes the new property “CT_A” to a higher level task/task object

Because of the distributed hierarchical structure and the possibility of propagating properties and determining the values at a higher level (without the application code of the higher level itself knowing or using these properties), it is possible to change the parameter values of the lower levels. By using the selection, it is possible to reduce the parameter values to desired (or, alternatively, predetermined) values. They may also be made available to the designers for selection for a designer dialogue. Due to the possibility of using the parameter names for propagating to the next-higher level, using the same task several times may be possible because no name conflicts occur. The property values may also be overwritten if the configuration of the lower level cannot be changed.

If the algorithm provides not only the possibility of specifying the actual value of a property, but also a reference to a cell in the matrix (see FIG. 4), having different properties of tasks read/written from the same target may be possible.

The search-sequence in the multi-level/multi-user matrix may be important. If the value of the parameter is determined in the external storage, there may initially be a search at the task level of the user/workplace/site structure. If no value is found, the search may continue step-by-step at the next level. If the higher level provides no value, default values may be determined. In the case of dynamic storage, the values may be stored along a multi-level/multi-user matrix, in order to achieve a different behavior depending on user, workplace, or site.

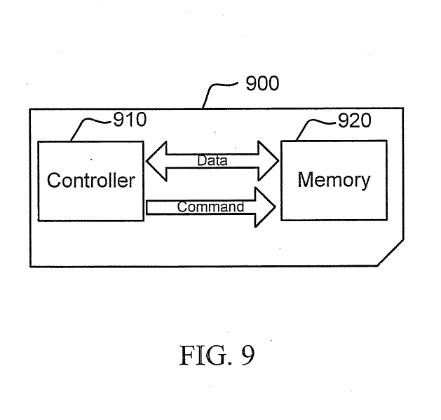

FIG. 9 is a schematic diagram illustrating a memory card 900 according to example embodiments. Referring to FIG. 9, a controller 910 and a memory 920 may exchange electric signals. For example, according to commands of the controller 910, the memory 920 and the controller 910 may exchange data. Accordingly, the memory card 900 may either store data in the memory 920 or output data from the memory 920. The memory card 900 may be included in the system for computed tomography described above in reference to FIG. 7. The memory 920 may include the property assessor 500 described above with regard to FIG. 5. The memory 920 may include a data structure including instructions to execute the method described above in reference to FIG. 8.

Such a memory card 900 may be used as a storage medium for various devices. For example, the memory card 1000 may be a multimedia card (MMC), a secure digital (SD) card, network server memory, a medical imaging device memory, medical workflow management system memory, and the like.

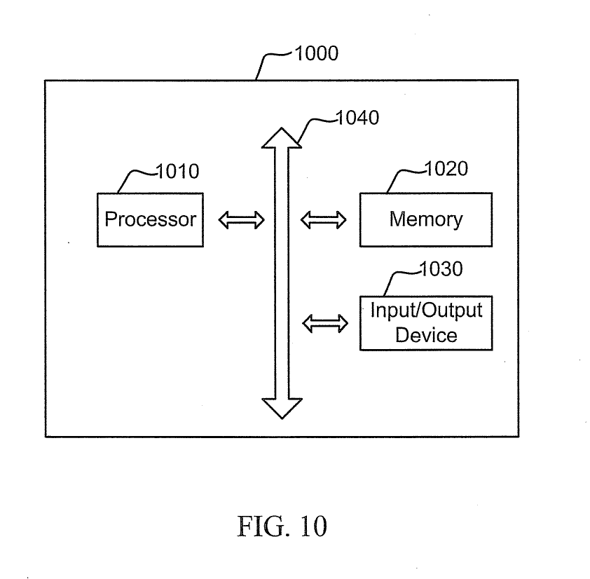

FIG. 10 is a block diagram roughly illustrating an electronic system 1000 according to example embodiments. Referring to FIG. 10, a processor 1010, an input/output device 1030, and a memory 1020 may perform data communication with each other by using a bus 1040. The processor 1010 may execute a program and control the electronic system 1000. The input/output device 1030 may be used to input/output data to/from the electronic system 1000. The electronic system 1000 may be connected to an external device, e.g. a personal processor or a network, by using the input/output device 1030 and may exchange data with the external device.

The memory 1020 may store codes or programs for operations of the processor 1010. For example, the memory 1020 may include a data structure including instructions to execute the method described above in reference to FIG. 8. For example, the electronic system 1000 may be included in computed tomography described above in reference to FIG. 7. For example, the memory 1020 may include the property assessor 500 described above with regard to FIG. 5.

For example, such an electronic system 1000 may embody various electronic control systems requiring the memory 1020, and, for example, may be used in medical devices, media players, navigation devices, network servers, medical imaging devices, medical workflow management systems, processors, household appliances and the like.

Alternative embodiments of the invention may be implemented as a computer program product for use with a computer system, the computer program product being, for example, a series of computer instructions, code segments or program segments stored on a tangible or non-transitory data recording medium (computer readable medium), such as a diskette, CD-ROM, ROM, or fixed disk, or embodied in a computer data signal, the signal being transmitted over a tangible medium or a wireless medium, for example, microwave or infrared. The series of computer instructions, code segments or program segments can constitute all or part of the functionality of the methods of example embodiments described above, and may also be stored in any memory device, volatile or non-volatile, such as semiconductor, magnetic, optical or other memory device.

Although the above example was described with regard to a computed tomography system, example embodiments are not limited thereto. For example, system may be another imaging system (e.g., MRI). Further, example embodiments are not limited to imaging systems. For example, example embodiments may be related to a clinical study system or other health care management system. Further, as one skilled in the art will appreciate, example embodiments may be related to any system using tasks and/or workflows and/or taskflows.

While example embodiments have been particularly shown and described, it will be understood by one of ordinary skill in the art that variations in form and detail may be made therein without departing from the spirit and scope of the claims. The invention being thus described, it will be obvious that the same may be varied in many ways. Such variations are not to be regarded as a departure from the invention, and all such modifications are intended to be included within the scope of the invention.

We claim:

1. A method to publish a task flow property, the method comprising:
determining whether or not a processing level of the task flow is an intermediate processing level;
generating a new property upon determining that the processing level is an intermediate processing level;
associating a relatively lower level property with the new property; and
publishing the new property to a relatively higher processing level in the task flow.

2. The method to publish a task flow property according to claim 1, wherein the generating step includes storing information associated with the relatively lower level property.

3. The method to publish a task flow property according to claim 1, wherein
the associating step includes storing info information associated with the relatively lower level property and the new property, and
the associating step includes storing information linking the relatively lower level property with the new property.

4. The method to publish a task flow property according to claim 1, wherein
the taskflow is associated with a plurality of user groups,
a flow of information is processed by at least one of the user groups, and
a search for information is processed by at least one of the user groups.

5. The method to publish a task flow property according to claim 4, wherein
each of the processing levels includes one or more of the user groups,
the flow of information is processed by at least one of the user groups associated by at least one of the processing levels, and
a search for information is processed by at least one of the user groups associated by at least one of the processing levels.

6. The method to publish a task flow property according to claim 5, wherein
the taskflow is associated with a plurality of designer tools, and
each of the processing levels is associated with one of the plurality of designer tools.

7. A computer readable medium, comprising:
a data structure including,
a task flow, the task flow including a plurality of tasks ordered hierarchically, and
code segments that when executed by a processor cause the processor to,
determine whether or not a processing level of the plurality of tasks is an intermediate processing level;
generate a new property upon determining that the processing level is an intermediate processing level;
associate a relatively lower level property with the new property; and
publish the new property to a relatively higher processing level in the task flow.

8. The computer readable medium according to claim 7, wherein the processor stores information associated with the relatively lower level property.

9. The method to publish a task flow property according to claim 7, wherein
the processor stores information associated with the relatively lower level property and the new property, and
the processor stores information linking the relatively lower level property with the new property.

10. The computer readable medium according to claim 7, wherein
the taskflow is associated with a plurality of user groups,
a flow of information is processed by at least one of the user groups, and
a search for information is processed by at least one of the user groups.

11. The computer readable medium according to claim 10, wherein
each of the processing levels includes one or more of the user groups,
the flow of information is processed by at least one of the user groups associated by at least one of the processing levels, and
a search for information is processed by at least one of the user groups associated by at least one of the processing levels.

12. The computer readable medium according to claim 11, wherein
the taskflow is associated with a plurality of designer tools, and
each of the processing levels is associated with one of the plurality of designer tools.

13. A medical work flow management system, comprising:
a processor; and
a memory on which a data structure is stored, the data structure including,
a task flow, the task flow including a plurality of tasks ordered hierarchically,
code segments that when executed by the processor cause the processor to,
determine whether or not a processing level of the plurality of tasks is an intermediate processing level;
generate a new property upon determining that the processing level is an intermediate processing level;
associate a relatively lower level property with the new property; and
publish the new property to a relatively higher processing level in the task flow.

14. The medical work flow management system according to claim 13, wherein the processor stores information associated with the relatively lower level property.

15. The medical work flow management system according to claim 13, wherein
the processor stores information associated with the relatively lower level property and the new property, and
the processor stores information linking the relatively lower level property with the new property.

16. The medical work flow management system according to claim 13, wherein
the taskflow is associated with a plurality of user groups,
a flow of information is processed by at least one of the user groups, and
a search for information is processed by at least one of the user groups.

17. The medical work flow management system according to claim 16, wherein
each of the processing levels includes one or more of the user groups,
the flow of information is processed by at least one of the user groups associated by at least one of the processing levels, and
a search for information is processed by at least one of the user groups associated by at least one of the processing levels.

18. The medical work flow management system according to claim 17, wherein
the taskflow is associated with a plurality of designer tools, and
each of the processing levels is associated with one of the plurality of designer tools.

19. A medical imaging device, comprising:
a processor; and
a memory on which a data structure is stored, the data structure including,
a task flow, the task flow including a plurality of tasks ordered hierarchically,
code segments that when executed by the processor cause the processor to,
determine whether or not a processing level of the plurality of tasks is an inter mediate processing level;
generate a new property upon determining that the processing level is an intermediate processing level;
associate a relatively lower level property with the new property; and
publish the new property to a relatively higher processing level in the task flow.

20. The medical imaging device according to claim 19, wherein the processor stores information associated with the relatively lower level property.

21. The medical imaging device according to claim 19, wherein
the processor stores information associated with the relatively lower level property and the new property, and
the processor stores information linking the relatively lower level property with the new property.

22. The medical imaging device according to claim 19, wherein
the taskflow is associated with a plurality of user groups,
a flow of information is processed by at least one of the user groups, and
a search for information is processed by at least one of the user groups.

23. The medical imaging device according to claim 22, wherein
each of the processing levels includes one or more of the user groups,
the flow of information is processed by at least one of the user groups associated by at least one of the processing levels, and
a search for information is processed by at least one of the user groups associated by at least one of the processing levels.

24. The medical imaging device according to claim 23, wherein
the taskflow is associated with a plurality of designer tools, and
each of the processing levels is associated with one of the plurality of designer tools.
